(19) United States
(12) Patent Application Publication
(10) Pub. No.: US 2005/0092846 A1
(43) Pub. Date: May 5, 2005

(54) Simulated smartmedia/XD-picture memory card capable of using various kinds on non-volatile memory

(75) Inventors: Robin Lai, Jiadong Township (TW); Edison Chang, Taichung City (TW); Gordon Yu, Taipei (TW)

Correspondence Address: BACON & THOMAS, PLLC, 625 SLATERS LANE, FOURTH FLOOR, ALEXANDRIA, VA, 22314, US

(73) Assignees: C-One Technology Corporation, Hsin-Chu City (TW); Pretec Electronics Corporation, Fremont, CA (US)

(21) Appl. No.: 10/878,325

(22) Filed: Jun. 29, 2004

(30) Foreign Application Priority Data
Oct. 31, 2003 (TW) 092130461

(51) Int. Cl. G06K 19/06

(52) U.S. Cl. 235/492

(57) ABSTRACT

A simulation SmartMedia/xD-Picture memory card capable of using various kinds of non-volatile memory has at least one non-volatile memory chip for storing data; a card interface and a controller. The card interface is defined with command, data and address signal for enabling an external host computer to access the data in the non-volatile memory chip. The controller is used for interpreting a command sent from the host computer and changing an address sent from the host computer to a valid address for the non-volatile memory chip to go to the non-volatile memory chip to write, read or delete the data.

### BACKGROUND OF THE INVENTION

1. Field of the Invention

The present invention relates to a memory card device and, more particularly, a simulated SmartMedia/xD-Picture memory card capable of using various kinds of non-volatile memory.

2. Description of the Related Art

With the growing popularity of digital cameras, PDAs, and other such portable electronic devices, as well as new IA concepts, consumers are demanding access to digital data with increasing frequency, which has increased growth in the small flash memory card market. Currently, flash memory cards are the only answer for these small portable, and delicate, electronic devices. FIG. 1 shows the structure of a SmartMedia/xD-Picture flash memory card, which packs a NAND flash memory chip 11 and uses the pins of the NAND flash memory chip 11 as an interface signal. File management is controlled by software in a host computer. Therefore, with the advantages of a simple structure, small dimensions, light weight, low power consumption and high cost benefits, flash memory cards have become the trend in the electronics market. However as the demand for larger and larger memory capacities is growing, increasing the memory capacity has become a common goal for manufacturers. For the SmartMedia/xD-Picture memory cards, a key aspect of the capacity is the memory chip that is inserted into the card.

In order to increase the memory capacity of the above mentioned SmartMedia/xD-Picture memory card, one method involves directly upgrading the memory chip with another memory chip having a larger capacity. For a NAND flash memory chip, when the memory capacity is upgraded from 512 M bit to 1 G bit, although the appearance and pins do not change, the internal structure changes from 1 Block=32 pages, 1 page=512+16 Bytes to 1 Block=64 pages, 1 page=2K+64 Bytes. When the memory capacity is upgraded from 1 G bits to 2 G bits, the addressing module changes from a 4 address cycle to a 5 address cycle, and so forth. Therefore, in SmartMedia/xD-Picture memory cards, upgrading the memory chips to increase the memory capacity will require changing both hardware and software designs of the host computer to support the memory chips with larger memory capacities.

Furthermore, another type of non-volatile memory that is frequently used for data storage is AND Flash. The structure and usage are different from NAND Flash; for example, with a 512 M bit memory capacity, the AND Flash structure is 1 page=2K+64 Bytes(AG-AND), where the NAND Flash structure is 1 page=512+16 Bytes. The AND Flash addressing scheme is 2 column address+2 row address(AG-AND), and the NAND Flash addressing scheme is 1 column address+3 row address. For 1 G bits memory capacity, the smallest unit of the AND Flash delete module is 4K+128 Bytes(AG-AND), whereas the smallest unit of the NAND Flash delete module is 128K+4K Bytes, and so forth. Therefore, in SmartMedia/xD-Picture memory cards, use of AND Flash will require changing both the hardware and software design of the host computer to support a memory chip with a larger memory capacity.

Therefore, it is desirable to provide a simulated SmartMedia/xD-Picture memory card capable of using various kinds of non-volatile memory to mitigate and/or obviate the aforementioned problems.

### SUMMARY OF THE INVENTION

A main objective of the present invention is to provide a simulated SmartMedia/xD-Picture memory card capable of using various kinds of non-volatile memory, which can relieve the limitations of memory chip structure, and expand the capacity of the SmartMedia/xD-Picture memory card.

In order to achieve the above-mentioned objective, the simulated SmartMedia/xD-Picture memory card capable of using various kinds of non-volatile memory includes at least one non-volatile memory chip for storing data; a card interface defined with command, data and address signal interface for enabling an external host computer to access the data in the non-volatile memory chip; and a controller for interpreting a command sent from the host computer and changing an address sent from the host computer to a valid address for the non-volatile memory chip to be passed on to the non-volatile memory chip to write, read or delete the data.

Other objects, advantages, and novel features of the invention will become more apparent from the following detailed description when taken in conjunction with the accompanying drawings.

### BRIEF DESCRIPTION OF THE DRAWINGS

FIG. 1 is a structure drawing of a prior art SmartMedia/xD-Picture memory card.

FIG. 2 is a structure drawing of a simulated SmartMedia/xD-Picture memory card in accordance with the present invention.

FIG. 3 is a block drawing of a controller in accordance with the present invention.

FIG. 4 is a schematic drawing of a memory card reading data in accordance with the present invention.

FIG. 5 is a schematic drawing of a memory card writing data in accordance with the present invention.

FIG. 6 is a schematic drawing of a memory card erasing data in accordance with the present invention.

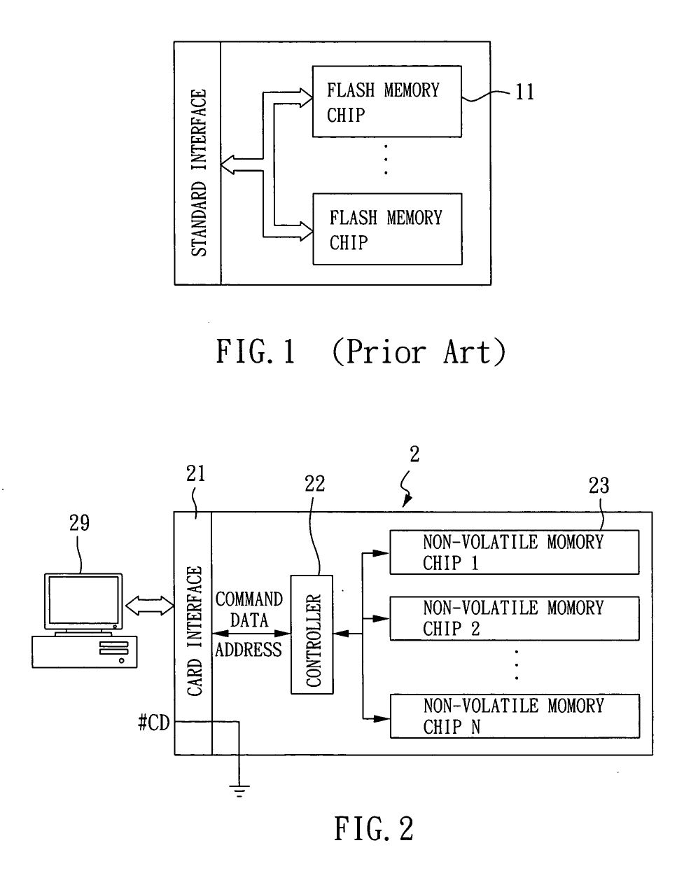

### DETAILED DESCRIPTION OF THE PREFERRED EMBODIMENT

FIG. 2 is a structure drawing of a simulated SmartMedia/xD-Picture memory card 2 in accordance with the present invention. The memory card 2 comprises a card interface 12, a controller 22, and at least one non-volatile memory chip 23. The card interface 12 is a standard SmartMedia/xD-Picture interface. The non-volatile memory chip 23 can be NAND, AND, AGAND or NOR flash memory.

The card interface 21 defines a command, data and address module interface behavior for enabling an external host computer 29 (such as a portable computer or a desktop computer) to access the data in the non-volatile memory chip 23 of the memory card 2. In this embodiment, the memory card 2 has N non-volatile memory chips 23, and the card interface 21 further has a card detection pin (#CD) for detecting whether the memory card is inserted or pulled.

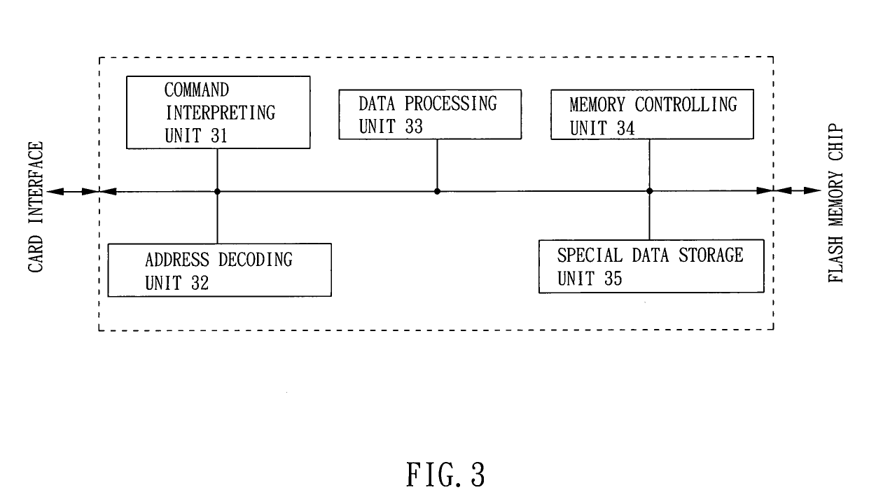

FIG. 3 is a block drawing of a controller in accordance with the present invention. The controller 22 further comprises a command interpreting unit 31, an address decoding unit 32, a data processing unit 33, a memory controlling unit 34 and a special data storage unit 35. The controller 22 is used for changing command/address/data sent from the host computer 29 to a format that is acceptable to the non-volatile memory chip 23 and corresponding to a proper storing area. The controller 22 can also determine identification commands and special commands sent from the host computer 29 and respond with required data from the special data storage unit 35 to the host computer 29.

When the memory card 2 is inserted into the host computer 29, the host computer 29 uses the detecting pin (#CD) of the card interface 21 to detect whether the memory card is positioned. For the memory card 2, the detecting pin needs to be grounded; and for the host computer 29, upon detecting the low potential in the pin, the host computer 29 should power up the memory card, and control and manage the memory card 2 according to the command cycle, address cycle, data reading cycle and data writing cycle in a standard sequence.

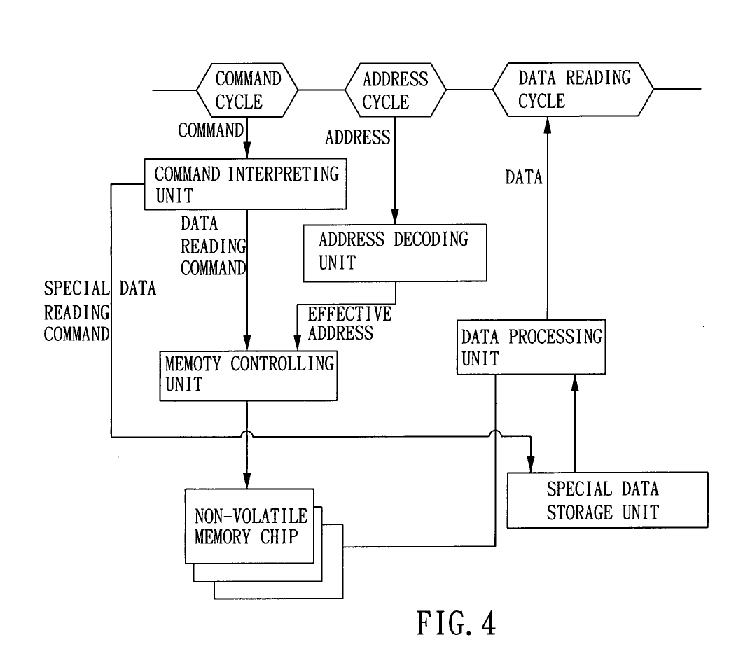

Please refer to FIG. 4. FIG. 4 is a schematic drawing of a memory card reading data according to the present invention. When the host computer 29 performs a data reading operation to the memory card by executing a command cycle, address cycle, data reading cycle and data writing cycle in the standard sequence to cause the memory card 2 to read data, as shown in FIG. 4, the command interpreting unit 31 of the controller 22 automatically determines the type of command. If the command is determined as a standard data reading command, it is sent to the memory controlling unit 34 for change into a proper format, and the memory controlling unit 34 also enables and passes the command to the non-volatile memory chip 23. The address decoding unit 32 analyzes an address that is requested by the host computer and changes the requested address to an accepted format and corresponding address for the non-volatile memory chip 23. The memory controlling unit 34 enables and passes the address to the non-volatile memory chip 23, and when the address cycle ends, the memory controlling unit 34 disables the unaddressed non-volatile memory chip 23 according to the address. Therefore, the data in the enabled non-volatile memory chip 23 is sent back to the host computer 29 via the data processing unit 33 to accomplish a data reading operation. If the command interpreting unit 31 determines that the command is a special data reading command, the memory controlling unit 34 disables the non-volatile memory chips 23, the data processing unit 33 reads data from the special data storage unit 35, and after the data reading cycle, the host computer 29 reads the data.

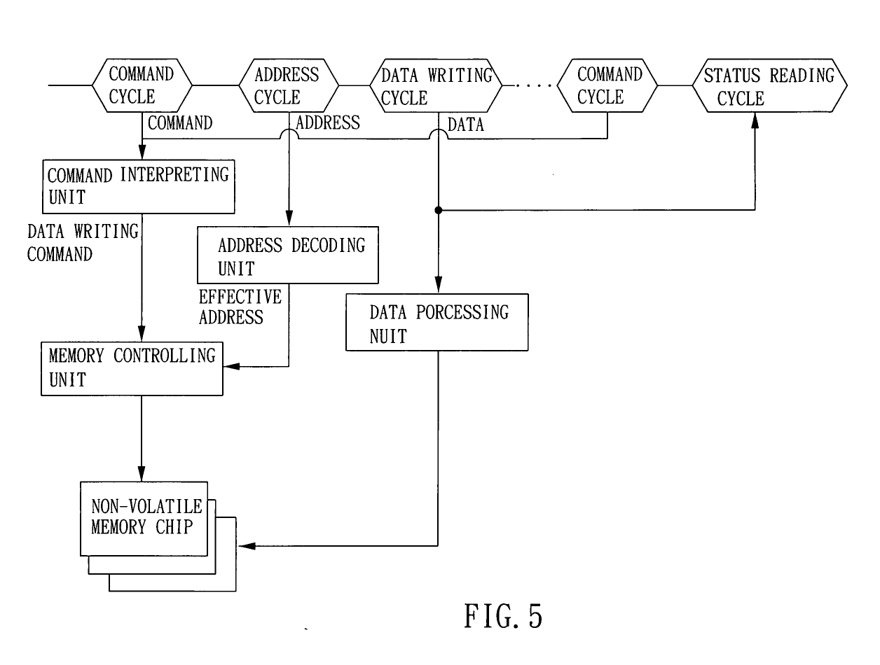

Please refer to FIG. 5. FIG. 5 is a schematic drawing of a memory card writing data in accordance with the present invention. The host computer 29 performs a data writing operation to the memory card by executing a command cycle, address cycle, data reading cycle and data writing cycle in the standard sequence. As shown in FIG. 5, the command interpreting unit 31 of the controller 22 automatically determines the type of command. If the command is a data writing command, it is sent to the memory controlling unit 34 for change into a proper format, and the memory controlling unit 34 also enables and passes the command to the non-volatile memory chip 23. The address decoding unit 32 analyzes an address that is requested by the host computer 29 and changes the requested address to an accepted format and corresponding address for the non-volatile memory chip 23. The memory controlling unit 34 enables and passes the address to the non-volatile memory chip 23, and after the address cycle ends, the memory controlling unit 34 disables the unaddressed non-volatile memory chip 23 according to the address. Therefore, the data in the enabled non-volatile memory chip 23 is sent from the host computer 29 via the data processing unit 33 to be written into the enabled non-volatile memory chip 23. One important characteristic is that the non-volatile memory chip 23 is continuously enabled until the host computer 29 performs a data writing operation to the memory card by executing command cycle and status reading cycle in a standard sequence.

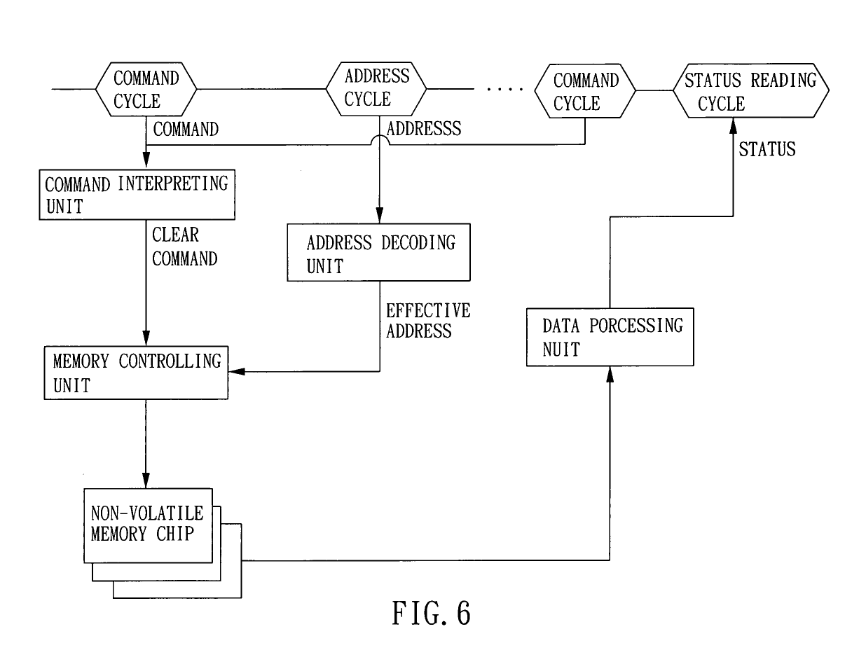

Please refer to FIG. 6. FIG. 6 is a schematic drawing of a memory card erasing data in accordance with the present invention. The host computer 29 performs a data clear operation to the memory card 2 by executing a command cycle, address cycle in a standard sequence. As shown in FIG. 6, the command interpreting unit 31 of the controller 22 automatically determines the type of command. If the command is determined to be a data clear command, it is sent to the memory controlling unit 34 for change into a proper format, and the memory controlling unit 34 also enables and passes the command to the non-volatile memory chip 23. The address decoding unit 32 analyzes an address that the host computer 29 requests to delete, and changes the requested address to an accepted format and corresponding address for the non-volatile memory chip 23. The memory controlling unit 34 enables and passes the address to the non-volatile memory chip 23, then after the address cycle ends, the memory controlling unit 34 disables the unaddressed non-volatile memory chip 23 in accordance with the address. Therefore, only the enabled non-volatile memory chip 23 performs the data clear operation. One important characteristic is that the non-volatile memory chip 23 is continuously enabled until the host computer 29 performs a data writing operation to the memory card by executing a command cycle and status reading cycle in a standard sequence.

According to the above-mentioned description, the present invention utilizes a controller in the system structure of the SmartMedia/xD-Picture memory card to solve the capacity problems related to upgrading the non-volatile memory without changing any external electronic device hardware, and the present invention can also use other types of non-volatile memory chips without the limitations of memory capacity extensions.

Although the present invention has been explained in relation to its preferred embodiment, it is to be understood that many other possible modifications and variations can be made without departing from the spirit and scope of the invention as hereinafter claimed.

1. A simulated SmartMedia/xD-Picture memory card capable of using various kinds of non-volatile memory comprising:
at least one non-volatile memory chip for storing data;
a card interface defined with command, data and address signal interface for enabling an external host computer to access the data in the non-volatile memory chip; and
a controller for interpreting a command sent from the host computer and changing an address sent from the host computer to a valid address for the non-volatile memory chip to be passed on to the non-volatile memory chip to write, read or delete the data.

2. The memory card as claimed in claim 1, wherein the card interface further comprises a card detection pin for detecting whether the memory card is inserted or removed.

3. The memory card as claimed in claim 1, wherein the card interface is a standard SmartMedia/xD-Picture interface.

4. The memory card as claimed in claim 1, wherein the non-volatile memory chip is NAND, AND, AGAND or NOR flash memory.

5. The memory card as claimed in claim 1, wherein the controller further comprises:
a command interpreting unit for interpreting the command from the host computer;
an address decoding unit for changing the address sent from the host computer to a valid address for the non-volatile memory chip; and
a memory controlling unit for operating the non-volatile memory chip according to the interpreted command and the valid address.

6. The memory card as claimed in claim 5, wherein the controller further comprises a data processing unit, and when the command from the host computer is interpreted as reading or writing data, the data is sent from the addressed non-volatile memory chip to the computer host or from the computer host to the addressed non-volatile memory chip.

7. The memory card as claimed in claim 6, wherein the controller further comprises a special data storage unit, and when the command from the host computer is interpreted as reading special data, the data processing unit reads data from the special data storage unit to send to the host computer.
